(19) United States
(12) Patent Application Publication
(10) Pub. No.: US 2024/0016695 A1
(43) Pub. Date: Jan. 18, 2024

(54) INTRAORAL APPARATUS AND METHODS FOR TREATING SKIN LAXITY

(71) Applicant: PerioTech, LLC, Palm Beach Gardens, FL (US)

(72) Inventors: Richard JOHNSON, Palm Beach Gardens, FL (US); Nicholas PURO, Sunny Isles Beach, FL (US)

(21) Appl. No.: 17/865,010

(22) Filed: Jul. 14, 2022

(51) Int. Cl. A61H 23/02

(52) U.S. Cl. CPC A61H 23/02; A61H 2201/10; A61H 2201/0165

(57) ABSTRACT

A device and method for treating facial skin laxity of a user includes an intraoral vibrational device having a mouthpiece for contacting the dentition to transmit the vibration to facial skin. Instructions are provided for the intraoral vibrational device by placing the mouthpiece over the dentition, applying a vibratory force during a predetermined number of sessions throughout a predetermined treatment period, wherein the skin laxity can be improved than without vibratory treatment.

### TECHNICAL FIELDS

This disclosure concerns treatments of facial skin laxity, more specifically, devices and methods to facilitate treatment of sagging skin, puffy face, forehead furrows, enlarged eye socket, sunken temples and other facial skin laxity symptoms using an intraoral vibration device.

### BACKGROUND

Facial skin laxity is the condition in which the skin loses its structure and stiffness, becoming loose and beginning to sag. Specifically, it includes but is not limited to, deep forehead furrows and frown lines, enlarged eye sockets, crow's feet, dropping of mouth corners, perioral lines, sunken temples, and the formation of jowls. Nearly everyone reaching a certain age will begin to experience one or more symptom of skin laxity, particularly around the face. Other factors may contribute to skin laxity include sun exposure, smoking, stress, and genetics. The common changes triggered by these factors are the decrease of collagen and elastin, the loss of bone and muscle strength, the reduction of hydration and hormones, as well as a slowing of the blood circulation.

It is generally known that the skin depends on both collagen and elastin to remain tight. Collagen and elastin are found in the deeper layer of the skin. Collagen, which can be considered as the skin's “building block”, is the primary structural protein and other connective tissues throughout the face. Elastin, a protein that functions like a spring within the elastic fibers of connective tissue, is what is responsible for the elasticity of the skin and other biological tissues. Skin laxity problems develop as the facial skin's production of collagen and elastin declines. Additionally, the research reveals that bone structure changes through bone formation and resorption. When there is more bone resorption than production, there is bone loss. A slight loss of the bone for the soft tissues of the face to hold on to adds to the appearance of excess or droopy skin. For example, the eye sockets grew larger while the bones that make up the sockets shrank. Similar losses of volume happen in the bones, including the brow bone, nose, upper jaw, and lower jaw. Currently, the most common facial treatments available involve an electric massager or facial cleaning device that is applied directly to the skin of the face to relieve skin laxity issues through vibrations. These treatments can be expensive and require active exertion by the therapist or the user.

### SUMMARY

According to an exemplary embodiment of the present disclosure, a method for treating facial skin laxity is described. The method includes identifying a user having at least one symptom of facial skin laxity, providing to the user an intraoral vibration device having a mouthpiece for contacting the dentition, and providing instructions for using the intraoral vibration device. The instruction includes placing the mouthpiece over the dentition and applying a vibratory force during a predetermined number of sessions throughout a predetermined treatment period. At least one symptom of skin laxity is improved compared to without vibratory treatment. According to one exemplary embodiment, the frequency ranges from about 90 Hz to about 140 Hz.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings constitute a part of this specification. The drawings illustrate several embodiments of the present disclosure and, together with the description, serve to explain the principles of the disclosed embodiments as set forth in the accompanying claims.

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1A depicts an illustrative intraoral vibrational device according to an exemplary embodiment of the disclosure;

FIG. 1B depicts an illustrative intraoral vibrational mouthpiece according to a further exemplary embodiment of the disclosure;

FIG. 2 depicts an illustrative intraoral vibrational device, such as that depicted in FIG. 1A placed in the mouth of a user, according to one aspect of the disclosure;

FIG. 3 depicts a perspective view of a SLAM STICK C accelerometer and data logger that records accelerations in three orthogonal directions of X, Y, and Z;

FIGS. 4A-4C are the charts showing accelerations measured at the forehead in three orthogonal directions of X, Y, and Z when using the intraoral vibration device;

FIGS. 5A-5C are the charts showing accelerations measured at the temple in three orthogonal directions of X, Y, and Z when using the intraoral vibration device;

FIGS. 6A-6C are the charts showing accelerations measured at the eye socket in three orthogonal directions of X, Y, and Z when using the intraoral vibration device;

FIGS. 7A-7C are the charts showing accelerations measured at the jawline and mandible in three orthogonal directions of X, Y, and Z when using the intraoral vibration device;

FIGS. 8A-8C are the charts showing accelerations measured at the neckline in three orthogonal directions of X, Y, and Z when using the intraoral vibration

Reference will now be made in detail to exemplary embodiments. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

### DETAILED DESCRIPTION

It is to be understood that both the foregoing general description and the following detailed description are exemplary and explanatory only and are not restrictive of the claims.

The disclosed embodiments relate to devices, systems, and methods for treating skin laxity. According to some aspects of the present disclosure, use of intraoral low-magnitude high-frequency vibration (LMHFV) for a user with skin laxity can help skin appear firmer as compared to without treatment, increasing the production of collagen and elastin, improving bone density and muscle strength, boosting blood circulation, and resulting in an improved appearance of fine lines and wrinkles as well as puffy skin.

According the aspects of the present disclosure, vibration is employed to slow down or even reverse symptoms of skin laxity, improving the texture and appearance of the skin. Without being bound to theory, it is believed that vibration treatment induces some structural changes in the deeper layer of the skin by stimulating certain collagen and elastin to be expressed at a higher level. Vibration improves skin laxity and other symptoms by increasing collagen and elastin levels.

Furthermore, studies indicate that low magnitude high frequency vibration (LMHFV), which is particularly beneficial for osteoporosis, can be osteogenic. According to several research, LMHFV therapy produces more osteoblasts, which are the cells responsible for making bone. LMHFV therapy improves bone strength by increasing bone formation and decreasing bone resorption. Additional research revealed that applying local vibration significantly increased muscle strength. Without being bound to theory, it is believed that enhancement of muscle strength involves regulating the differentiation of mesenchymal stem cells to build these tissues; mesenchymal stem cell lineage allocation is positively promoted by vibration signals. Vibration can thereby reduce skin laxity by enhancing bone and muscle strength.

Additionally, vibration will have an impact on skin hydration, hormone release, and blood circulation. A series of vibration treatments may enhance hydration and lessen transepidermal water loss. Moreover, vibration releases human growth hormone that is lipolytic and helps reduce and redistribute fat tissue and battle wrinkles in addition to healing damaged cells, enabling a quicker skin recovery. Furthermore, vibration can enhance blood flow, circulation and drainage, as well as oxygen intake in the skin, which can relieve puffiness and improve absorption and performance of the skin care products.

In order to enhance skin laxity, this disclosure offers an intraoral vibration device that people can easily and readily use by placing it in their mouth and biting down on it. The device transmits vibration to face areas like the forehead, temple, lower eye socket, jawline, mouthline, and neckline.

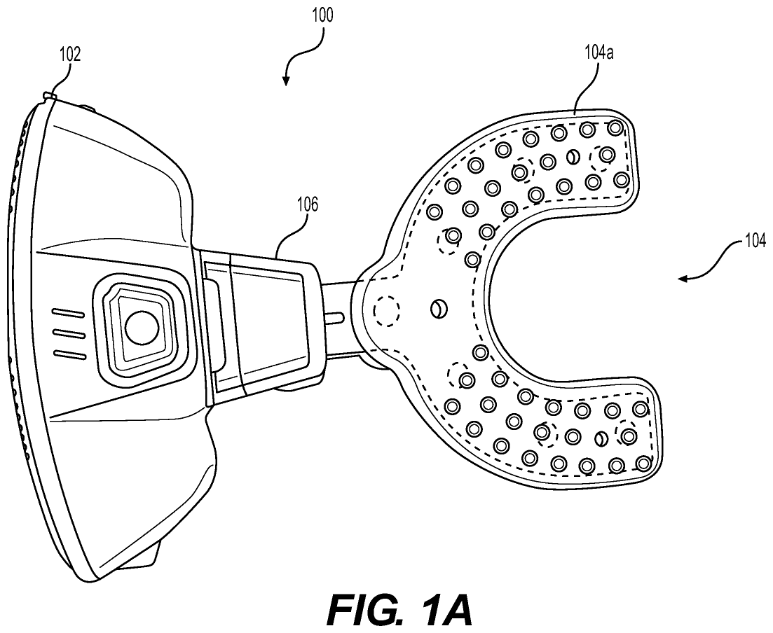

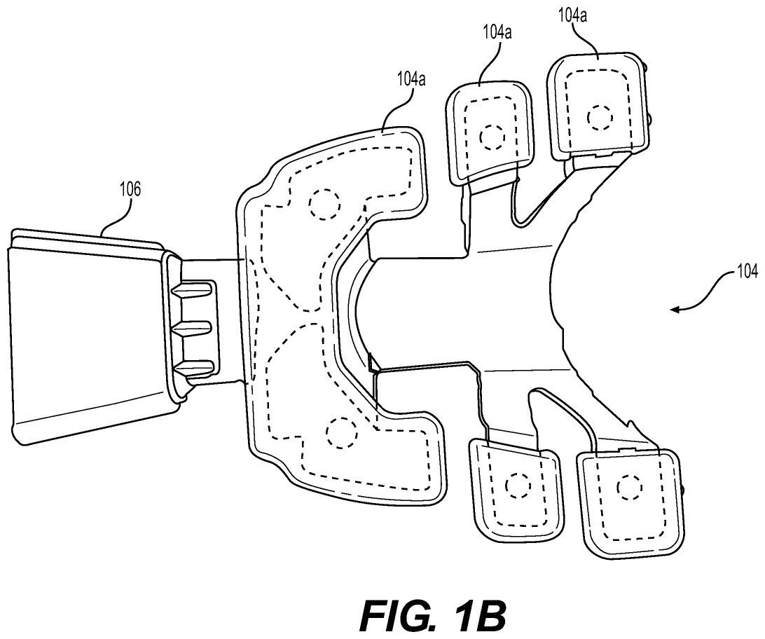

In one aspect, with reference to FIGS. 1A and 1, use of the device 100 providing LMHVFV for 2-5 minutes daily at least once before or after bedtime can relieve facial skin laxity or puffiness. Advantageously, vibration applied to the dentition of a user with skin laxity will, through bone and facial tissue conduction of the vibration, be applied to the forehead, temples, eye socket, jaw/mandible, and neckline. Further advantageously, the vibration stimulates facial skin to improve forehead furrows, frown lines, crow's feet, sunken temples, enlarged eye sockets, dropping of mouth corners, perioral lines, the formation of jowls and necklines.

Described herein are intraoral LMHFV devices, which in certain embodiments include a mouthpiece configured to transmit vibration to all or a portion of the user's face skin. In some embodiments, the appliance can be configured to engage with a user's teeth alone or can be configured to engage with a user's teeth and gums. Stimulation thus applied can help to increase blood flow and other cells of repair to the skin, including that provided by vibration conducted through the teeth and bony structures of the head and face. The appliance can be configured to contact one or more teeth, the gum line only, or both one or more teeth and the gumline.

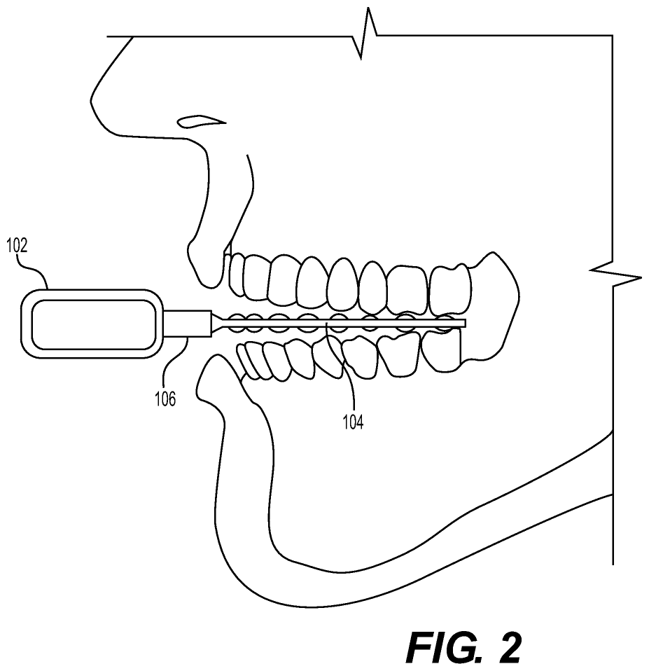

Referring to FIGS. 1A-1B, an exemplary dental device 100 includes a mouthpiece 104 operatively connected to a housing 102 via a connector 106. The mouthpiece 104 can be separable from the housing 102 for interchangeability between users or for ease of cleaning. The mouthpiece 104 can include one or more oral tissue-contacting portion 104a, such as a biteplate or probe for contacting teeth, gums or other oral tissues. As shown, in FIGS. 1A-1B, the mouthpiece can include a biteplate which can be appropriately shaped to cover occlusal surfaces of some or all of a user's dentition. Other shapes for the mouthpiece are possible. For example, the mouthpiece can be configured to abut the lingual and buccal lateral sides of the alveolar ridge either with or without occlusal contact or, when no teeth are present, contact with gums overlying the alveolar ridge. A vibration generator can be located in the mouthpiece 104 or the housing 102 to vibrate the mouthpiece 104. In some embodiments (not shown) the vibrators can be mounted to the biteplate, and in still further embodiments the entire device can be intraoral. The housing 102 can also include the electronics to run the motor the vibrator, collect usage and device operation data, collect data from sensors in the mouthpiece or base, and store data in memory. The housing 102 can include a data interface which can be wired or wireless to allow a data connection to other devices. The housing 102 can also include a power interface to allow charging of any onboard power sources, such as batteries or capacitor banks. The mouthpiece 104 can be electrically interconnected to the housing 102 via the connector 106. FIG. 2 depicts an illustrative dental device 100, such as that described above with reference to FIG. 1A, inserted in the mouth of a human user and engaging the occlusal surfaces of the molars. The mouthpiece of the dental device 100 can, as described above, be sized and shaped to contact any dental tissue, including some or all of the teeth, specific regions of the gums, or both.

As is known in the art, the vibration generator can include an electric motor connected to an eccentric weight, or can be a piezo generator, as well as other known expedients. Accordingly, when the mouthpiece 104 is placed in a user's mouth and the intraoral vibration device 100 is turned on, the vibration of the mouthpiece 104 will place vibratory force repetitively on the teeth and transmit to facial skin tissues and muscles.

LMHFV therapy according to the present disclosure is also advantageously configured to improve skin texture with better skin care product penetration. In one aspect, a user uses at least one skin care product, including lotion, serum, essence, eye cream, moisturizers, face-mask, anti-aging cream, or anti-wrinkle cream on the face, which can be applied before and during LMHFV. The pores may open up as a result of the LMHFV's vibration, increasing oxygen intake. Enriched oxygen molecules are produced that create an anti-bacterial action and a “natural” thermal tissue warming. This reaction helps blood vessels push away toxins, absorbing the topically applied skin care product. Thus, the skin's cells are strengthened with nutrients and moisturizing substance. As a result, the treatment leaves the skin feeling immediately revitalized and considerably softer.

LMHFV in one aspect helps reduce the puffy face. There are many reasons for facial puffiness, such as inflammation, allergies, medications, bug bites or stings, sun burn, and a salty diet. Here, we only concentrate on dehydration, which might arise from a diet high in salt or alcohol the night before, which causes blood vessels to enlarge and create water retention. The use of LMHFV in the morning after sleep can advantageously help enhance blood circulation and drainage of lymph, decrease water retention, to obtain a tighter skin sooner than without treatment.

In some embodiments, a user having symptoms of skin laxity can be instructed to use the appliance for a recommended time and duration to improve skin appearance. In an example, the user can be instructed to use the appliance for five minutes daily over a four-month period. The vibration can be applied along multiple axes or selected to be primarily on a single axis. The primary anatomic reference directions with reference to a standing human are superior-inferior (up and down), anterior-posterior (front to back), medial-lateral (side to side). Because mastication places loading on oral structures primarily in the superior-inferior direction through mandibular action, it may be advantageous to choose vibrational loading along other axes either separately or in combination.

### Vibrational Skin Laxity Treatment Devices

According to an aspect of the present disclosure, an intraoral vibrational device that vibrates at one or more predetermined frequencies is provided. In some embodiments, the vibrational frequency is fixed within a lower bound and an upper bound. The lower bound can be greater than about 110 Hz, 105 Hz, 100 Hz, 95 Hz, 90 Hz, 85 Hz, 80 Hz, 75 Hz, 70 Hz, 65 Hz, 60 Hz, 55 Hz, 50 Hz, 45 Hz, or less. The upper bound can be greater than about 140 Hz, 150 Hz, 160 Hz, 170 Hz, 180 Hz, 190 Hz, 200 Hz, or more. In some embodiments, the frequency varies within a lower and an upper bound. In some embodiments two or more frequencies, fixed or varying, are employed.

In some embodiments, the duration of a treatment session can be specified to be greater than about 30 seconds, 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, or more; or specified to be less than about 20 min, 19 min, 18 min, 17 min, 16 min, 15 min, 14 min, 13 min, 12 min, 10 min, 9 min, 8 min, 7 min, 6 min, 5 min, 4 min, 3 min, 2 min, 1 min, 30 seconds, or less.

FIG. 1A depicts an intraoral vibrational device according to an example. The intraoral vibrational device can include a mouthpiece and a housing connected to each other by a connector. The mouthpiece is configured to be provided between the occlusal surfaces of a user's teeth, and to be bit down by the user to contact the user's dentition during the treatment. The mouthpiece can cover at least the teeth or implant around which accelerating graft conversion is desired. A vibrational source is configured to provide vibration to the mouthpiece at a preset frequency and acceleration. The vibrational source can be placed in the mouthpiece or the housing to provide vibration.

To achieve the maximum desired results of treatment for skin laxity, further studies are still needed to optimize the parameters of LMHFV. Such parameters may include frequency, acceleration, and dosage. Dosage may include duration per use, number of uses per day, or number of days of use, either consecutively or on a certain schedule.

In some embodiments, the vibrational source may be connected to the mouthpiece in such a way that the vibration provided is in the sagittal plane of a user's mouth. A motor may be included in the vibrational source to provide such vibration. The motor may be of any suitable type known in the art. The motor may be placed in any part of the intraoral vibration device. In some embodiments, the motor may be placed in the mouthpiece. In some embodiments, the motor may be placed in the housing. The motor can be configured and arranged so as to provide, in use, vibration at a frequency as disclosed herein. The motor, when in use, may be further configured to provide vibration at an acceleration magnitude. In some embodiments, the mouthpiece of an intraoral vibrational device can have an acceleration within a lower bound and an upper bound. The lower bound can be greater than about 0.010 G, 0.015 G, 0.020 G, 0.025 G, 0.030 G, 0.035 G, 0.040 G, 0.045 G, 0.050 G, 0.055 G, 0.060 G, or more; or less than about 0.060 G, 0.055 G, 0.050 G, 0.045 G, 0.040 G, 0.035 G, 0.030 G, 0.025 G, 0.020 G, 0.015 G, 0.010 G, or less. The upper bound can be greater than about 0.27 G, 0.28 G, 0.29 G, 0.30 G, 0.31 G, 0.32 G, 0.33 G, 0.34 G, 0.35 G, or more; or less than about 0.35 G, 0.34 G, 0.33 G, 0.32 G, 0.31 G, 0.30 G, 0.29 G, 0.28 G, 0.27 G, or less. In some embodiments, the dosage or parameters of the LMHFV is based upon the facial anatomical locations to be treated and can be varied according to location or severity of laxity.

In some embodiments, the mouthpiece can be replaced by a skin-contact piece specifically designed for the treatment area. The skin-contact piece can be made to fit anywhere along the forehead, temple, eye socket, jawline, or neckline.

In some embodiments, sensors may be added to the intraoral vibrational device, either on the vibrational device, or on the mouthpiece. The sensors may be configured to detect and monitor the parameters of the vibration, for example, frequencies and acceleration magnitudes. The sensors may also be configured to detect if the user has bitten down on the mouthpiece correctly. The sensors may be accelerometers, gyroscopes, proximity sensors, pressure sensors, humidity sensors, temperature sensors, or any combinations of them.

### Method for Treating Skin Laxity

According to yet another aspect of the present disclosure, a method for treating skin laxity is described. The method includes providing the mouthpiece of the intraoral vibrational device to a user and providing instructions to the user. The instruction may include placement guidelines and dosage information. The dosage information may include duration of each treatment session, number of sessions in a day, number of days, etc. For example, the instruction may instruct a user to use the intraoral vibrational device for number of times per day. In some embodiments the treatment frequency can be specified to be once per day, twice per day, 3 times per day, 4 times per day, 5 times per day, 6 times per day, 7 times per day, 8 times per day, 9 times per day, or more. In some embodiments the duration of treatment can be specified to be about 1 day, 1 week, 2 weeks, 3 weeks, 1 month, 2 months, 3 months, 4 months, 5 months, 6 months, 7 months, 8 months, 9 months, 10 months, 11 months, 1 year, or more. In some embodiments, the treatment frequency can vary over different treatment periods. For example, the treatment frequency can be specified to be more than once per day for a first period of time, such as 30 or 60 days, and then reduced to once per day thereafter.

In some embodiments, the method may further include configuring the vibrational source providing an axial vibratory force to the mouthpiece. The axial vibratory force may be eventually applied to the dentition through the mouthpiece, which is clamped down by the teeth. The vibratory force (e.g., acceleration magnitudes, frequencies, etc.) can be adjusted by selecting preset values, or fine-tuned by users, technicians, or healthcare professionals.

According to yet another aspect of the present disclosure, a method for detecting skin laxity is described. The method includes steps of identifying a user with skin laxity or puffy face, applying a vibrational stimulus to a portion of the dentition or alveolar ridge, applying one or more vibration sessions over a period of time, and tracking the appearing of skin laxity or puffy face over time. In some embodiments, the method may further include modifying the LMHFV treatment in response to a user's skin appearance.

### Example

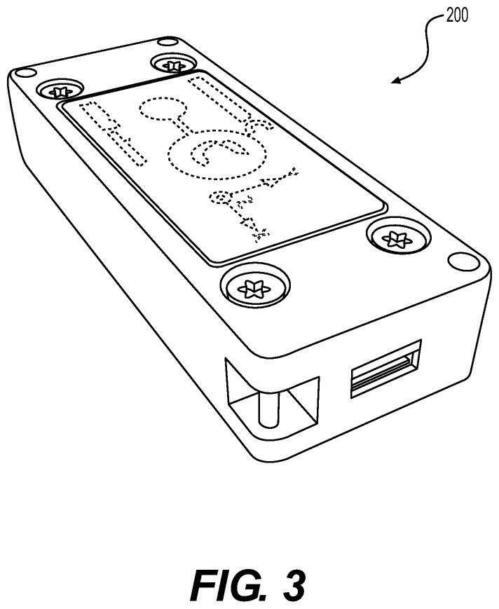

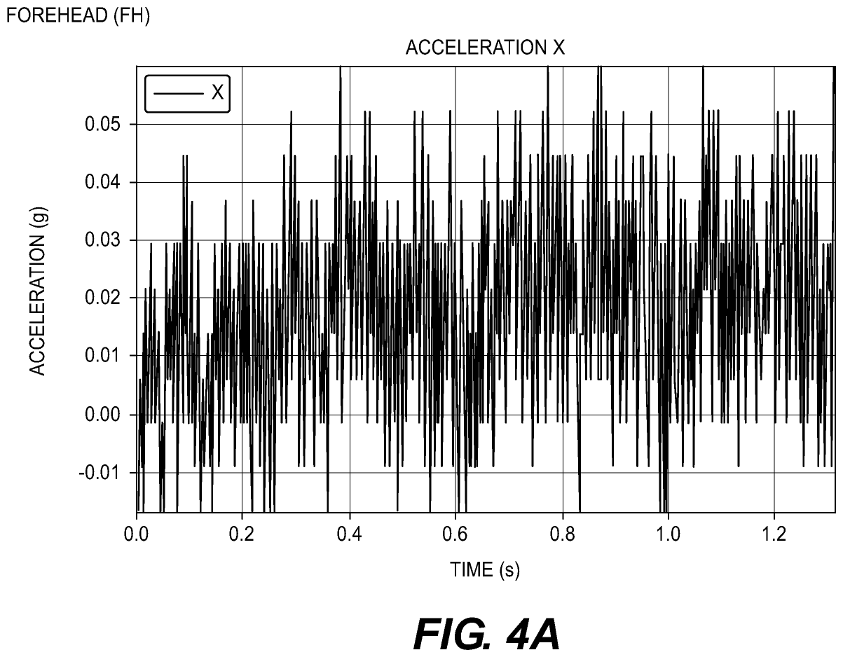

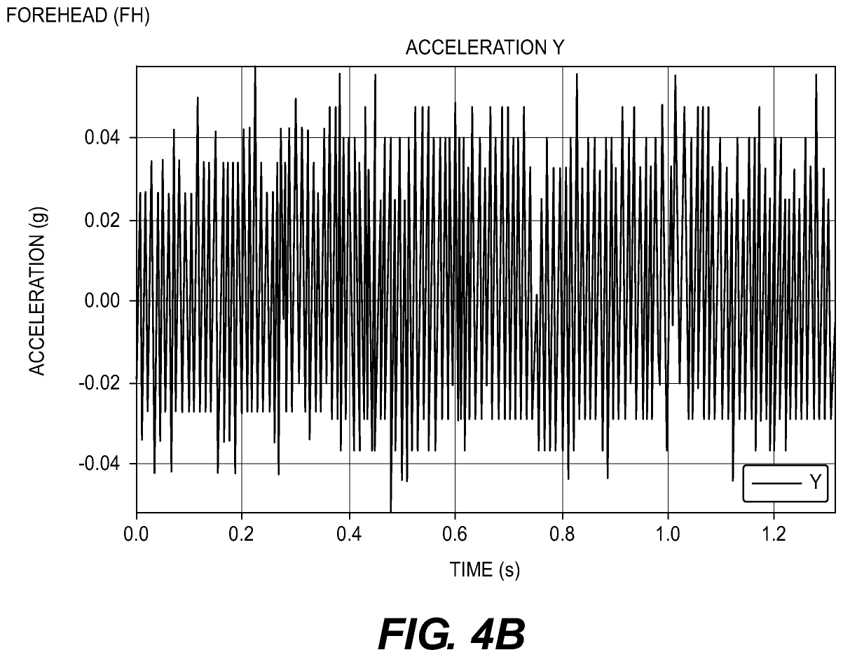

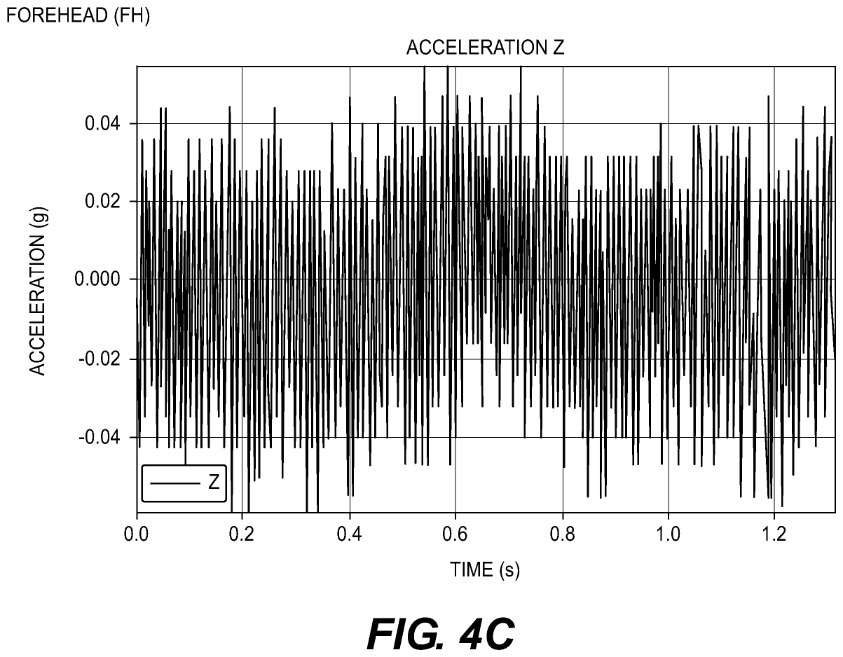

With reference to FIG. 3, a vibration sensor 200 that measures the acceleration of vibrations in the three directions of X, Y, and Z is shown. The acceleration measurement results at the locations including the forehead, temple, eye socket, jaw, and neckline over time are shown in FIGS. 4-8, with the intraoral LMHFV clamped by teeth.

### Forehead

An intraoral vibrational device with LMHFV operating at 100 Hz was employed by the user. The vibration travels to the area of the forehead through the skeleton and soft tissues. The acceleration at the forehead was measured using a vibration sensor as shown in FIG. 3 in the X, Y, and Z directions. The outcomes are displayed in FIGS. 4A-4C. At the forehead, a 3D peak acceleration of 0.08 G was measured. Because the vibration increases the formation of collagen and elastin and strengthens the muscles surrounding the forehead area, it helps to minimize skin laxity, such as forehead wrinkles and frown furrows.

### Temple

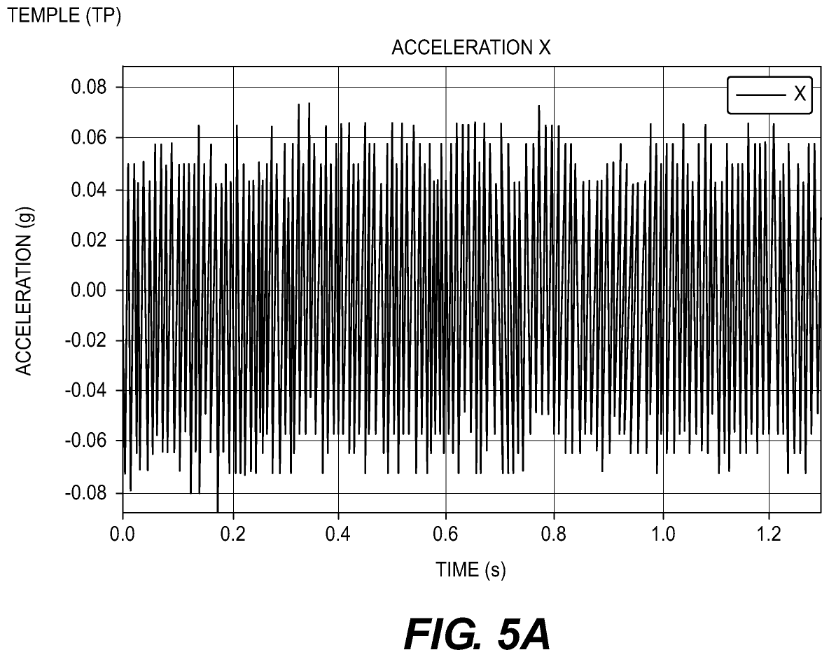

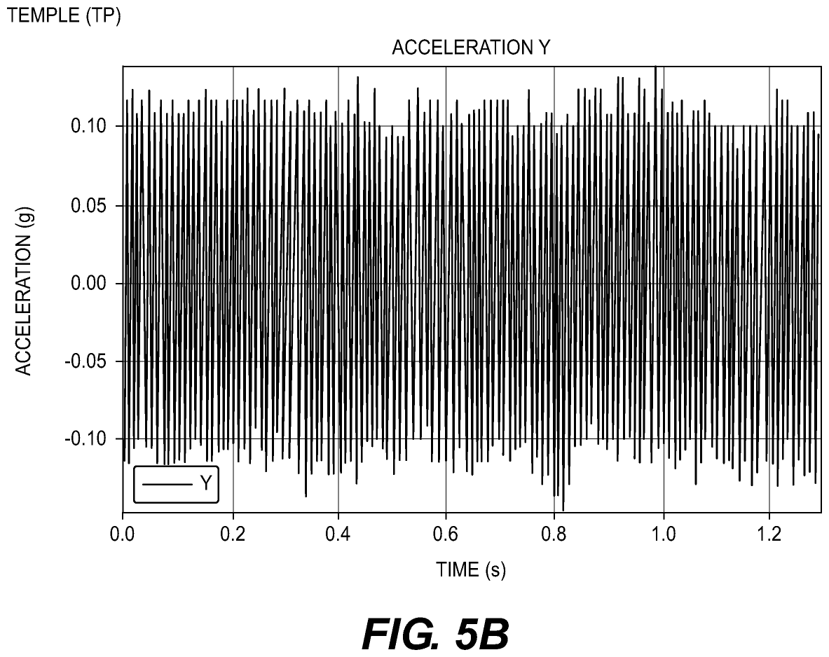

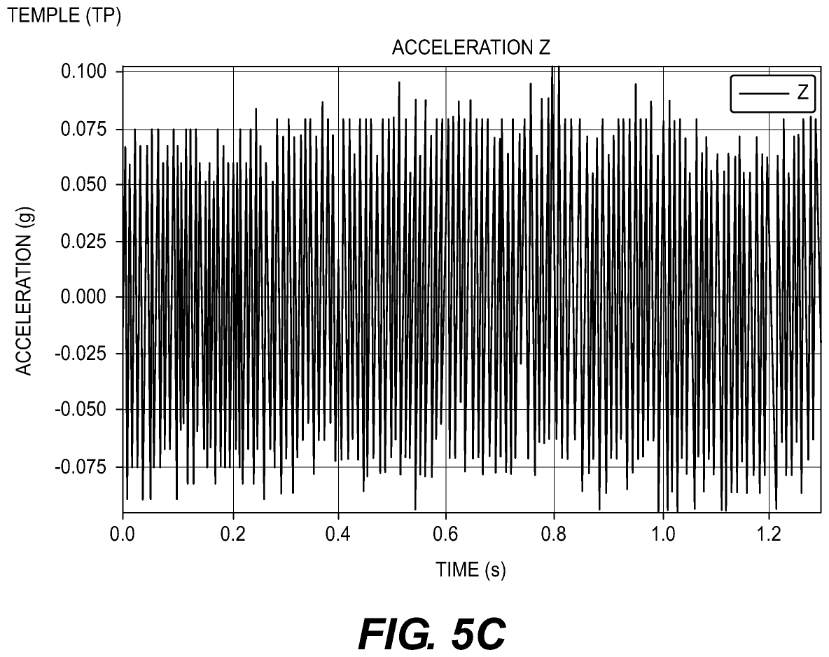

An intraoral vibrational device with LMHFV operating at 100 Hz was used by the user. The skeleton and soft tissues convey the vibration to the temple region. A vibration sensor, as seen in FIG. 3, was used to measure the acceleration at the forehead in the X, Y, and Z directions. The outcomes are displayed in FIGS. 5A-5C. The intraoral vibration device's transmitted 3D peak acceleration measured at the temple was 0.15 G. The vibration may enhance bone formation and decrease bone resorption in addition to improving the production of collagen and elastin, alleviating the sunken temple problem.

### Eye Sockets

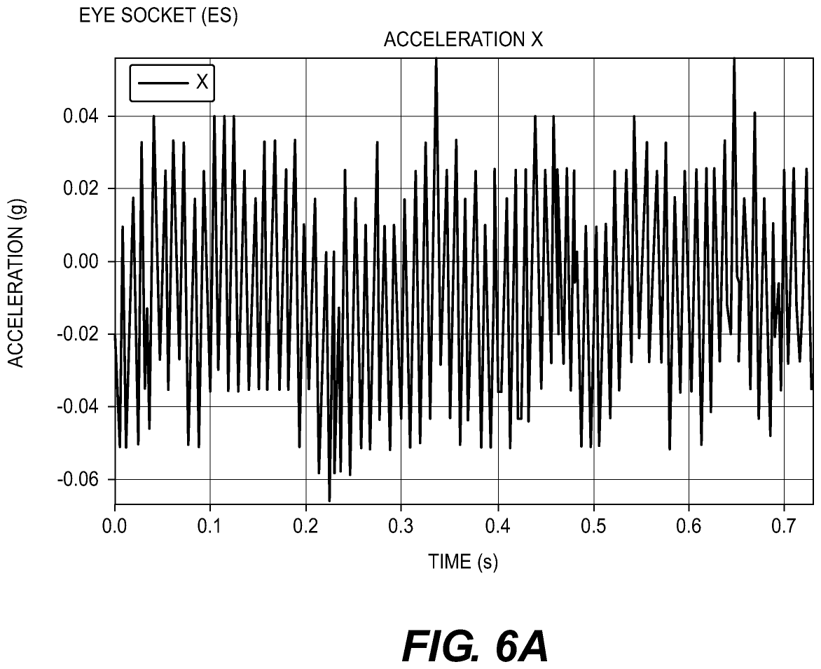

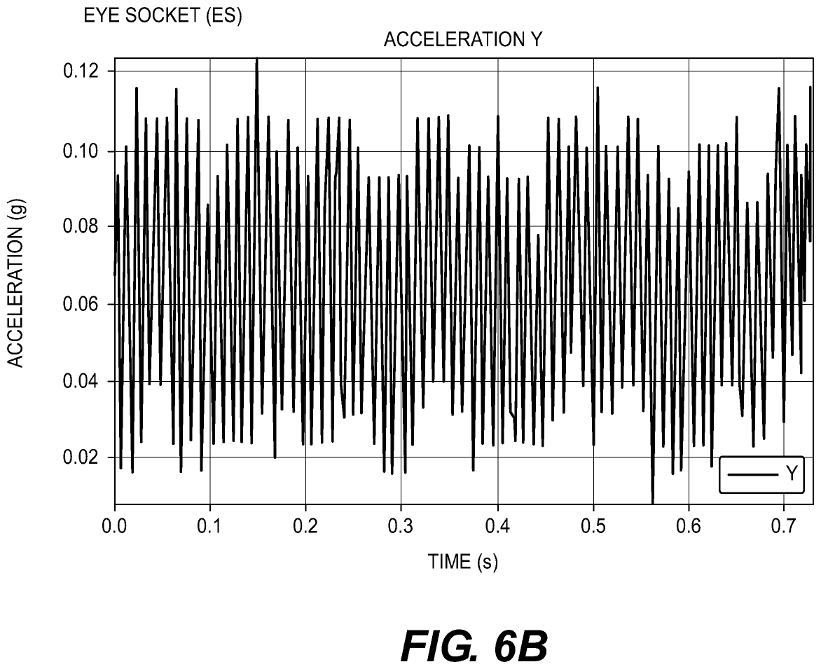

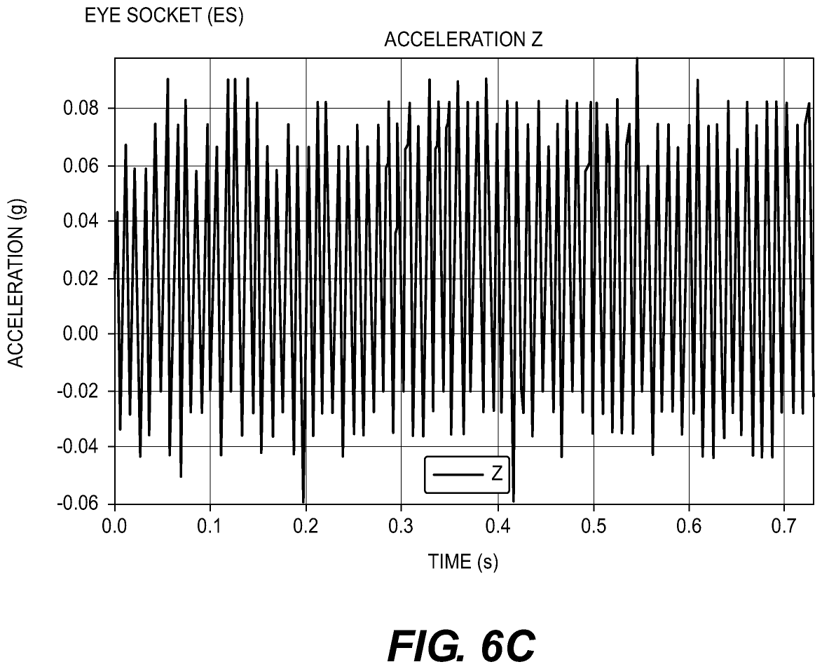

A user employed an intraoral vibrational device with LMHFV running at 100 Hz. The vibration is transmitted to the area around the eye socket by the skeleton and soft tissues. The acceleration at the eye socket in the X, Y, and Z axes was measured by a vibration sensor, as shown in FIG. 3. The results are shown in FIGS. 6A-6C. The transmitted 3D peak acceleration of the intraoral vibration device, as measured at the eye sockets, was 0.15 G. The transmitted vibration at the eye socket area may promote blood flow, collagen and elastin synthesis, and muscle strength to alleviate skin laxity, including enlarged eye sockets and crow's feet.

### Jawline/Mandible

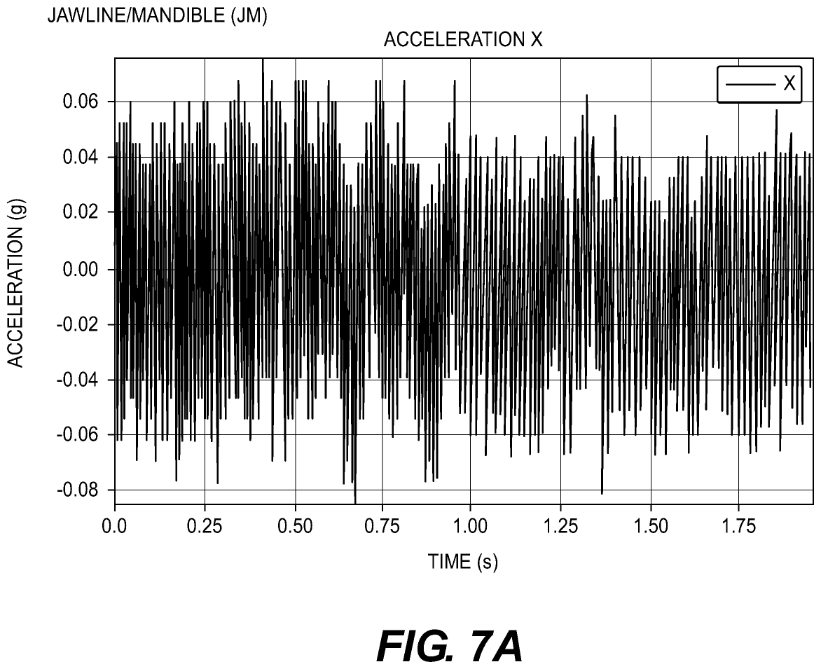

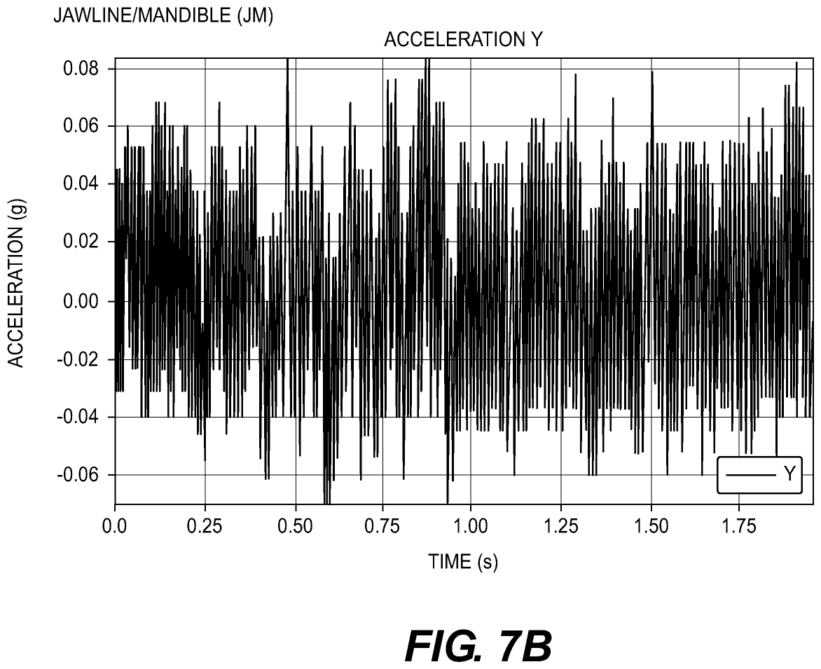

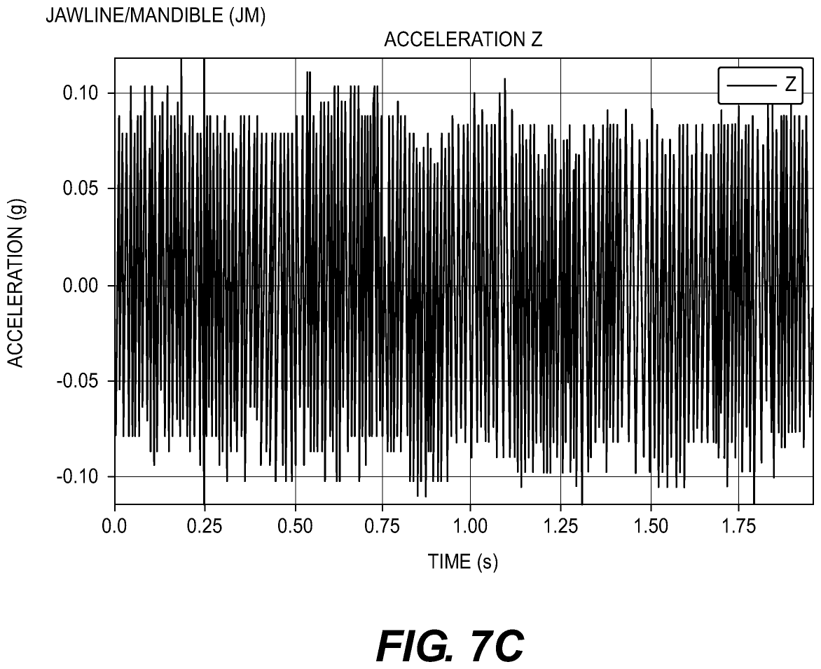

A user used an intraoral vibrational device with LMHFV running at 100 Hz. The skeleton and soft tissues transfer the vibration to the region near the jawline and mandible. A vibration sensor was used to determine the acceleration at the jawline and mandible in the X, Y, and Z axes, as displayed in FIG. 3. The results are shown in FIGS. 7A-7C. The transmitted 3D peak acceleration of the intraoral vibration device, as measured at the jawline and mandible, was 0.13 G. The transmitted vibration at the jawline and mandible area may promote collagen and elastin synthesis, bone formation and muscle strength to make the skin and face shape firmer.

### Neckline

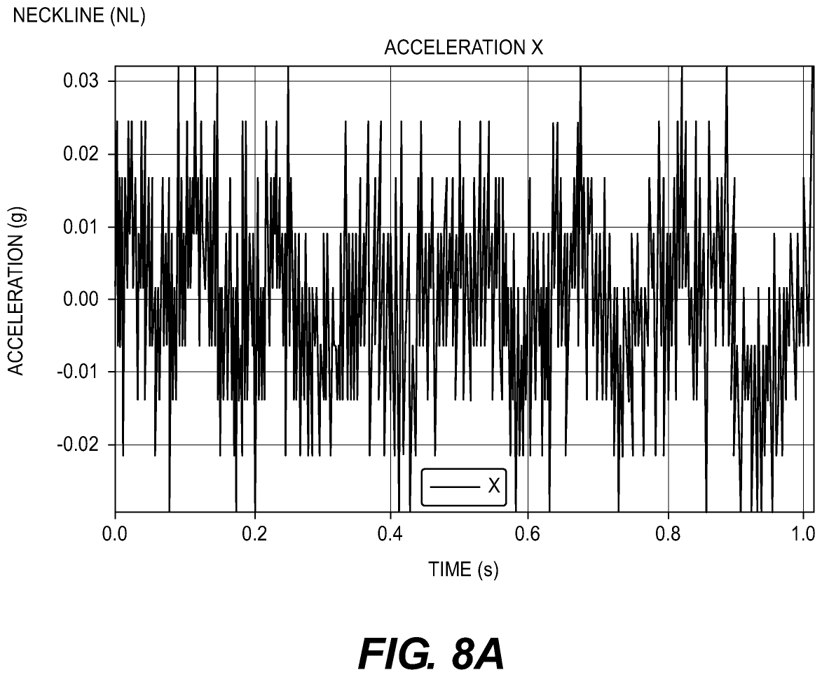

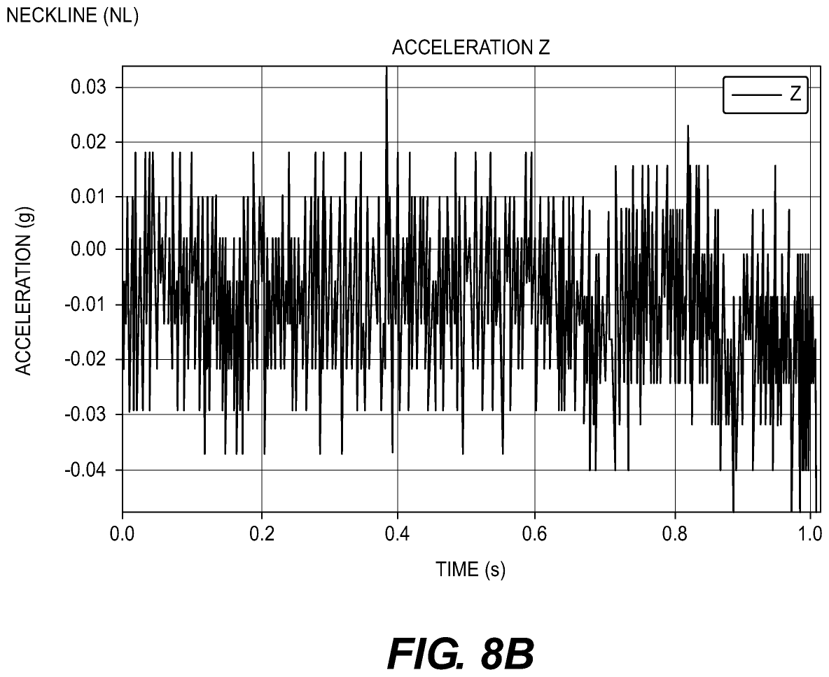

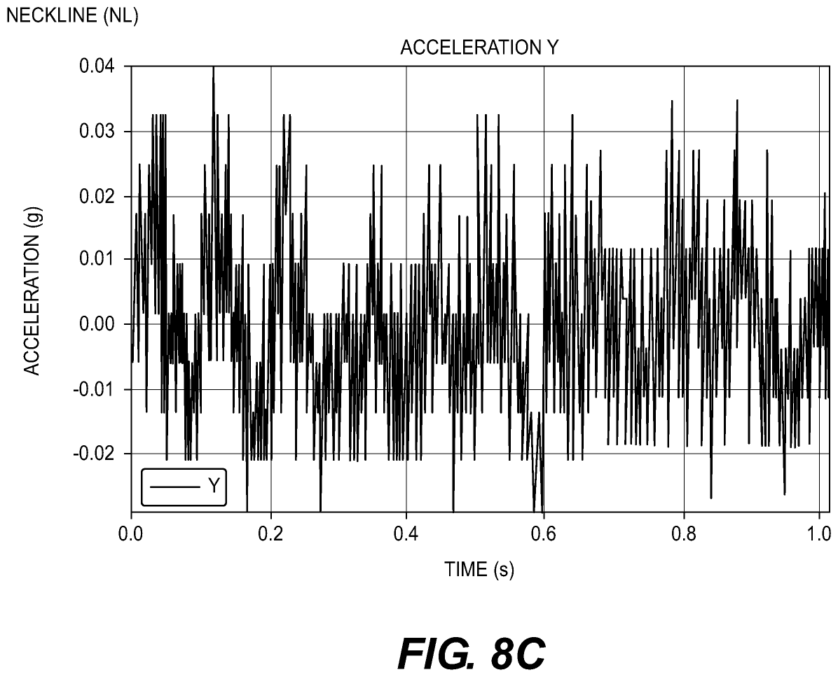

A user used an intraoral vibrational device with LMHFV operating at 100 Hz. The vibration is transmitted to the area around the neckline by the skeleton and soft tissues. The acceleration at the eye socket in the X, Y, and Z axes was measured by a vibration sensor, as shown in FIG. 3. The results are shown in FIGS. 8A-8C. The transmitted 3D peak acceleration of the intraoral vibration device, as measured at the eye sockets, was 0.04 G. The transmitted vibration at the neckline area may encourage the production of collagen and elastin, enhance blood circulation, and facilitate deeper penetration of skin products to lessen wrinkles and skin laxity there.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A method for treating facial skin laxity, comprising:
identifying a user having at least one symptom of facial skin laxity;
providing to the user an intraoral vibration device having a mouthpiece for contacting the dentition; and
providing instructions for using the intraoral vibration device, the instruction comprising:
placing the mouthpiece over the dentition;
applying a vibratory force during a predetermined number of sessions throughout a predetermined treatment period;
wherein at least one symptom of skin laxity is improved compared to without intraoral vibratory treatment.

2. The method of claim 1, wherein the frequency is ranging from about 90 Hz to about 140 Hz.

3. The method of claim 1, wherein the session time is ranging from 30 seconds to 20 minutes.

4. The method of claim 1, wherein the acceleration of the mouthpiece ranged from 0.010 G to 0.35 G.

5. The method of claim 1, wherein a vibration source can be placed in the mouthpiece.

6. The method of claim 1, wherein a vibration source can be placed in a housing that connects to the mouthpiece through a connector.

7. The method of claim 1, wherein the sessions are repeated at least once per day.

8. The method of claim 1, wherein the sessions are repeated more than once per day for a first period of time and reduce to once per day thereafter.

9. The method of claim 7, wherein the first period of time can be 30 days or 60 days.

10. The method of claim 1, wherein the treatment period is from 1 day to 5 years.

11. The method of claim 1, wherein the skin laxity facial anatomical locations includes forehead, temple, lower eye socket, jawline or neckline.

12. The method of claim 1, wherein the skin laxity symptoms include at least one of forehead wrinkles, brown furrows, enlarged eye sockets, crow's feet, dropping of mouth corners, perioral lines, sunken temples, or the formation of jowls.

13. The method of claim 1, wherein treatment includes improving the skin cream or skin care product penetration on facial area.

14. The method of claim 1, further comprising:
identifying skin laxity location needed treatment on the facial of the user; and
adjusting the dosage or parameters of the LMHFV based upon the facial anatomical locations.
